(19) United States
(12) Patent Application Publication
(10) Pub. No.: US 2026/0005294 A1
(43) Pub. Date: Jan. 1, 2026

(54) POSITIVE ELECTRODE MATERIAL, POSITIVE ELECTRODE, AND BATTERY

(71) Applicants: Panasonic Holdings Corporation, Osaka (JP); TOYOTA JIDOSHA KABUSHIKI KAISHA, Aichi (JP)

(72) Inventors: Yuta SUGIMOTO, Hyogo (JP); Kazuya HASHIMOTO, Osaka (JP); Keita MIZUNO, Osaka (JP)

(21) Appl. No.: 19/317,972

(22) Filed: Sep. 3, 2025

Related U.S. Application Data
(63) Continuation of application No. PCT/JP2024/001656, filed on Jan. 22, 2024.

(30) Foreign Application Priority Data
Mar. 7, 2023 (JP) 2023-034948

(51) Int. Cl. H01M 10/0562; C01G 51/42; C01G 53/42; H01M 10/0525

(52) U.S. Cl. CPC H01M 10/0562; C01G 51/42; C01G 53/42; H01M 10/0525; H01M 2300/0068

(57) ABSTRACT

A positive electrode material according to the present disclosure includes: a coated active material including a positive electrode active material and a coating layer including a first solid electrolyte, the coating layer coating at least a portion of a surface of the positive electrode active material; and a second solid electrolyte. The first solid electrolyte includes Li, Ti, M, and X, the M is at least one selected from the group consisting of metalloid elements and metal elements except for Li and Ti, and the X is at least one selected from the group consisting of F, Cl, Br, and I. The second solid electrolyte includes Li and S. A ratio of a mass of the first solid electrolyte to a total mass of the positive electrode active material and the first solid electrolyte is 1.00% or more and 4.10% or less.

This application is a continuation of PCT/JP2024/001656 filed on Jan. 22, 2024, which claims foreign priority of Japanese Patent Application No. 2023-034948 filed on Mar. 7, 2023, the entire contents of both of which are incorporated herein by reference.

### BACKGROUND OF THE INVENTION

### 1. Field of the Invention

The present disclosure relates to a positive electrode material, a positive electrode, and a battery.

### 2. Description of Related Art

JP 2016-18735 A describes a technique of manufacturing a composite active material by coating a positive electrode active material with an oxide solid electrolyte and further coating the positive electrode active material with a sulfide solid electrolyte.

### SUMMARY OF THE INVENTION

In conventional techniques, it is desired to suppress an increase in the internal resistance of batteries.

The present disclosure provides a positive electrode material including:
a coated active material including a positive electrode active material and a coating layer including a first solid electrolyte, the coating layer coating at least a portion of a surface of the positive electrode active material; and
a second solid electrolyte, wherein
the first solid electrolyte includes Li, Ti, M, and X,
the M is at least one selected from the group consisting of metalloid elements and metal elements except for Li and Ti,
the X is at least one selected from the group consisting of F, Cl, Br, and I,
the second solid electrolyte includes Li and S, and
a ratio of a mass of the first solid electrolyte to a total mass of the positive electrode active material and the first solid electrolyte is 1.00% or more and 4.10% or less.

According to the technique of the present disclosure, an increase in the internal resistance of the battery can be suppressed.

### BRIEF DESCRIPTION OF THE DRAWINGS

FIG. 1 is a cross-sectional view schematically showing the configuration of a positive electrode material according to Embodiment 1.

FIG. 2 is a cross-sectional view schematically showing the configuration of a battery according to Embodiment 2.

### DETAILED DESCRIPTION

### (Findings Underlying the Present Disclosure)

When a battery including a solid electrolyte is repeatedly charged and discharged, oxygen can be generated from the positive electrode active material. The generated oxygen oxidizes the solid electrolyte, increasing the internal resistance of the battery. The increase in internal resistance causes various issues such as a decrease in output voltage, heat generation in the battery, and a decrease in discharge capacity. Accordingly, a technique suitable for suppressing an increase in the internal resistance of batteries including solid electrolytes is desired.

Embodiments of the present disclosure are described below with reference to the drawings. The present disclosure is not limited to the following embodiments.

### Embodiment 1

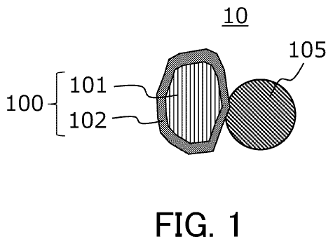

FIG. 1 is a cross-sectional view schematically showing the configuration of a positive electrode material according to Embodiment 1. A positive electrode material 10 includes a coated active material 100 and a second solid electrolyte 105. The coated active material 100 is composed of a positive electrode active material 101 and a coating layer 102. The coating layer 102 includes a first solid electrolyte. The coating layer 102 coats at least a portion of the surface of the positive electrode active material 101. The coating layer 102 may coat only a portion of the surface of the positive electrode active material 101, or may uniformly coat the surface of the positive electrode active material 101. The second solid electrolyte 105 includes Li and S.

In the coating layer 102, the first solid electrolyte includes Li, Ti, M, and X. M is at least one selected from the group consisting of metalloid elements and metal elements except for Li and Ti. X is at least one selected from the group consisting of F, Cl, Br, and I. In the positive electrode material 10, the ratio of the mass of the first solid electrolyte to the total mass of the positive electrode active material 101 and the first solid electrolyte is 1.00% or more and 4.10% or less. The ratio of the mass of the first solid electrolyte to the total mass of the positive electrode active material 101 and the first solid electrolyte is hereinafter also referred to as a “ratio MA1/MAt”.

The “metalloid elements” include B, Si, Ge, As, Sb, and Te.

The “metal elements” include all the elements in Groups 1 to 12 of the periodic table except hydrogen and all the elements in Groups 13 to 16 of the periodic table except B, Si, Ge, As, Sb, Te, C, N, P, O, S, and Se. That is, the metal elements are a group of elements that can become a cation when forming an inorganic compound with a halogen element.

The first solid electrolyte can be a solid electrolyte containing halogen, that is, a halide solid electrolyte. Halide solid electrolytes exhibit excellent oxidation resistance. Accordingly, coating the positive electrode active material 101 with the first solid electrolyte can suppress oxidation of the second solid electrolyte 105. Consequently, an increase in the internal resistance of a battery including the positive electrode material 10 can be suppressed, suppressing the degradation of the battery and thus leading to an improvement in the cycle characteristics of the battery including the positive electrode material 10.

When the ratio MA1/MAt satisfies the above range, the positive electrode active material 101 is sufficiently coated with the first solid electrolyte, fully achieving the above effect. Furthermore, when the ratio MA1/MAt satisfies the above range, the positive electrode material 10 has sufficient electronic conductivity. The ratio MA1/MAt may be 1.00% or more and 4.01% or less, 1.10% or more and 4.01% or less, 1.10% or more and 3.80% or less, 1.10% or more and 3.60% or less, 1.30% or more and 3.70% or less, or 1.60% or more and 3.60% or less. In some cases, the ratio MA1/MAt may be 1.10% or more and 4.10% or less, 1.30% or more and 4.10% or less, or 1.60% or more and 4.01% or less.

The total mass MAt of the positive electrode active material 101 and the first solid electrolyte is the sum of the mass MA2 of the positive electrode active material 101 and the mass MA1 of the first solid electrolyte. The mass MA1 of the first solid electrolyte is the total mass of the first solid electrolyte in the powder of the positive electrode material 10. The mass MA2 of the positive electrode active material 101 is the total mass of the positive electrode active material 101 in the powder of the positive electrode material 10. That is, the ratio MA1/MAt is the value determined from a certain amount of the entire powder of the positive electrode material 10.

The above ratio MA1/MAt can also be calculated based on the amount of material charged, and can also be calculated by the method described below. A positive electrode including the positive electrode material 10 is analyzed by inductively coupled plasma emission spectrometry. A quantitative analysis is performed on an element that is contained in the positive electrode active material 101 but not contained in the first solid electrolyte and on an element that is contained in the first solid electrolyte but not contained in the positive electrode active material 101. Consequently, the mass ratio between the positive electrode active material 101 and the first solid electrolyte can be determined, thereby allowing the calculation of the ratio MA1/MAt. It is also possible to calculate the ratio MA1/MAt from the composition ratio on the particle cross section analyzed by energy dispersive X-ray spectroscopy using a scanning electron microscope.

In the positive electrode material 10, the second solid electrolyte 105 and the coated active material 100 may be in contact with each other. In this case, the coating layer 102 and the second solid electrolyte 105 are in contact with each other. The positive electrode material 10 may include a plurality of particles of the second solid electrolyte 105 and a plurality of particles of the coated active material 100.

### <Positive Electrode Active Material>

The positive electrode active material 101 includes a material having properties of occluding and releasing metal ions (e.g., lithium ions). As the positive electrode active material 101, a lithium-containing transition metal oxide, a transition metal fluoride, a polyanion material, a fluorinated polyanion material, a transition metal sulfide, a transition metal oxysulfide, a transition metal oxynitride, or the like can be used. In particular, when a lithium-containing transition metal oxide is used as the positive electrode active material 101, the battery can be manufactured at a reduced cost and exhibit an increased average discharge voltage. Examples of lithium-containing transition metal oxides include Li(NiCoAl)O₂, Li(NiCoMn)O₂, and LiCoO₂.

The positive electrode active material 101 is in the form of, for example, particles. The shape of the particles of the positive electrode active material 101 is not particularly limited. The shape of the particles of the positive electrode active material 101 can be spherical, ellipsoidal, flaky, or fibrous.

The coated active material 100 may have a median diameter of 0.1 μm or more and 100 μm or less. When the coated active material 100 has a median diameter of 0.1 μm or more, the coated active material 100 and the second solid electrolyte 105 can form a favorable dispersion state in the positive electrode material 10. Consequently, the charge and discharge characteristics of the battery are improved. When the coated active material 100 has a median diameter of 100 μm or less, a sufficient diffusion rate of lithium within the coated active material 100 is ensured. Consequently, the battery can operate at high output.

The coated active material 100 may have a larger median diameter than the second solid electrolyte 105. In this case, the positive electrode active material 101 and the second solid electrolyte 105 can form a favorable dispersion state.

In the present specification, the “median diameter” means the particle diameter at a cumulative volume equal to 50% in the volumetric particle size distribution. The volumetric particle size distribution is measured, for example, using a laser diffractometer or an image analyzer.

The coated active material 100 may have a specific surface area of 0.60 m²/g or more and 1.40 m²/g or less, 0.60 m²/g or more and 1.30 m²/g or less, 0.60 m²/g or more and 1.20 m²/g or less, 0.68 m²/g or more and 1.16 m²/g or less, or 0.68 m²/g or more and 1.15 m²/g or less. In some cases, the coated active material 100 may have a specific surface area of 0.80 m²/g or more and 1.40 m²/g or less, 0.80 m²/g or more and 1.30 m²/g or less, 0.80 m²/g or more and 1.20 m²/g or less, 0.80 m²/g or more and 1.16 m²/g or less, or 0.81 m²/g or more and 1.15 m²/g or less. In the present specification, the specific surface area refers to the BET specific surface area measurable by the BET method.

### <Coating Layer>

The coating layer 102 includes the first solid electrolyte. The first solid electrolyte has ionic conductivity. Ionic conductivity is typically lithium-ion conductivity. The coating layer 102 is provided on the surface of the positive electrode active material 101. The coating layer 102 may include the first solid electrolyte as the main component, or may include only the first solid electrolyte. The “main component” means a component having the highest mass content. “Include only the first solid electrolyte” means that no materials other than the first solid electrolyte are intentionally added, except for unavoidable impurities. For example, raw materials of the first solid electrolyte and by-products generated in the preparation of the first solid electrolyte are included in unavoidable impurities. The ratio of the mass of unavoidable impurities to the total mass of the coating layer 102 may be 5% or less, 3% or less, 1% or less, or 0.5% or less.

The first solid electrolyte is a material including Li, Ti, M, and X. M and X are as described above. Such a material exhibits excellent ionic conductivity and excellent oxidation resistance. Therefore, the positive electrode material 10 including the coating layer 102 containing the first solid electrolyte improves the charge and discharge efficiency of the battery and the thermal stability of the battery.

M may include at least one selected from the group consisting of Ca, Mg, Al, Y, Ni, Fe, Cr, and Zr. M may include at least one selected from the group consisting of Ca, Mg, Al, Y, and Zr. According to such a configuration, the halide solid electrolyte exhibits high ionic conductivity.

M may include Al (=aluminum). That is, the halide solid electrolyte may contain Al as a metal element. When M includes Al, the halide solid electrolyte exhibits high ionic conductivity.

The halide solid electrolyte serving as the first solid electrolyte is represented, for example, by the following composition formula (1). In the composition formula (1), α, β, γ, and δ are each independently greater than 0.

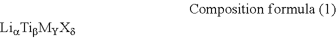

The halide solid electrolyte represented by the composition formula (1) exhibits higher ionic conductivity compared to halide solid electrolytes that consist of Li and a halogen element, such as LiI. Therefore, when the halide solid electrolyte represented by the composition formula (1) is used in a battery, the charge and discharge efficiency of the battery can be improved.

In the composition formula (1), M may be Al to further enhance the ionic conductivity of the first solid electrolyte.

The halide solid electrolyte serving as the first solid electrolyte may be represented by the following composition formula (2). In the composition formula (2), M2 is at least one selected from the group consisting of Zr, Ni, Fe, and Cr, m is the valence of M2, and 0.1<x<0.9, 0≤y<0.1, 0≤z<0.1, and 0.8<b≤1.2 are satisfied.

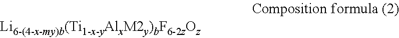

In the composition formula (2), when M2 includes a plurality of elements, m represents the sum of the products obtained by multiplying the composition ratio of each element by the valence of the element. For example, when M2 includes an element Me1 and an element Me2 where the composition ratio of the element Me1 is a1, the valence of the element Me1 is m1, the composition ratio of the element Me2 is a2, and the valence of the element Me2 is m2, then m is expressed as m1a1+m2a2.

The halide solid electrolyte may consist substantially of Li, Ti, Al, and X. Here, “the halide solid electrolyte consists substantially of Li, Ti, Al, and X” means that the molar ratio (i.e., mole fraction) of the sum of the amounts of substance of Li, Ti, Al, and X to the total of the amounts of substance of all the elements constituting the halide solid electrolyte is 90% or more. In one example, the molar ratio (i.e., mole fraction) may be 95% or more. The halide solid electrolyte may consist of Li, Ti, Al, and X.

In the halide solid electrolyte, the ratio of the amount of substance of Li to the sum of the amounts of substance of Ti and Al may be 1.12 or more and 5.07 or less to further enhance the ionic conductivity of the first solid electrolyte.

The halide solid electrolyte serving as the first solid electrolyte may be represented by the following composition formula (3). In the composition formula (3), 0<x<1 and 0<b≤1.5 are satisfied.

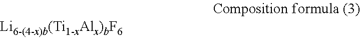

The halide solid electrolyte having this composition exhibits high ionic conductivity.

In the composition formula (3), 0.1≤x≤0.9 may be satisfied to enhance the ionic conductivity of the first solid electrolyte.

In the composition formula (3), 0.1≤x≤0.7 may be satisfied.

The upper and lower limits of the range of x in the compositional formula (3) can be defined by any combination of numerical values selected from 0.1, 0.3, 0.4, 0.5, 0.6, 0.67, 0.7, 0.8, and 0.9.

In the composition formula (3), 0.8≤b≤1.2 may be satisfied to enhance the ionic conductivity of the first solid electrolyte.

The upper and lower limits of the range of b in the composition formula (3) can be defined by any combination of numerical values selected from 0.8, 0.9, 0.94, 1.0, 1.06, 1.1, and 1.2.

The halide solid electrolyte may be crystalline or amorphous.

The shape of the halide solid electrolyte is not limited. Examples of the shape include acicular, spherical, and ellipsoidal shapes. The halide solid electrolyte may be in the form of particles.

When the halide solid electrolyte is in the form of, for example, particles (e.g., spherical), the solid electrolyte may have a median diameter of 0.01 μm or more and 100 μm or less.

The halide solid electrolyte may be a sulfur-free solid electrolyte. In this case, generation of sulfur-containing gases, such as hydrogen sulfide gas, from the solid electrolyte can be avoided. A sulfur-free solid electrolyte means a solid electrolyte represented by a composition formula that is free of the element sulfur. Accordingly, a solid electrolyte containing a trace amount of sulfur, for example, a solid electrolyte having a sulfur content of 0.1 mass % or less, belongs to sulfur-free solid electrolytes. The halide solid electrolyte may further contain oxygen as an anion other than a halogen element.

The coating layer 102 has a thickness of, for example, 1 nm or more and 500 nm or less. When the thickness of the coating layer 102 is appropriately adjusted, contact between the positive electrode active material 101 and the second solid electrolyte 105 can be sufficiently suppressed. The thickness of the coating layer 102 can be determined by thinning the coated active material by ion milling or other methods and observing a cross section of the coated active material using a transmission electron microscope. The average value of the thickness measured at any multiple positions (e.g., five points) can be regarded as the thickness of the coating layer 102.

### <Manufacturing Method for Halide Solid Electrolyte>

The halide solid electrolyte can be manufactured, for example, by the following method. Here, a manufacturing method for the halide solid electrolyte represented by the composition formula (1) is exemplified.

Raw material powders are prepared and mixed to obtain the desired composition. The raw material powders may be, for example, halides.

In one example where the target composition is Li_{2.7}Ti_{0.3}Al_{0.7}F₆, LiF, TiF₄, and AlF₃ are mixed in a molar ratio of approximately 2.7:0.3:0.7. The raw material powders may be mixed in a molar ratio adjusted in advance to offset a composition change that can occur during the synthesis process.

The raw material powders are reacted with each other mechanochemically (i.e., by mechanochemical milling) in a mixing device, such as a planetary ball mill, to obtain a reaction product. The reaction product may be fired in a vacuum or in an inert atmosphere. Alternatively, the mixture of the raw material powders may be fired in a vacuum or in an inert atmosphere to obtain a reaction product. The firing is conducted, for example, at 100° C. or more and 400° C. or less for 1 hour or more. To suppress a composition change during the firing, the raw material powders may be fired in a hermetically sealed container, such as a quartz tube.

The halide solid electrolyte is obtained by these methods.

### <Second Solid Electrolyte>

The second solid electrolyte 105 includes Li and S. In other words, the second solid electrolyte 105 includes a sulfide solid electrolyte. Sulfide solid electrolytes exhibit high ionic conductivity and can improve the charge and discharge efficiency of the battery. On the other hand, sulfide solid electrolytes exhibit poor oxidation resistance; however, the technique of the present disclosure can be applied to achieve a favorable effect.

The second solid electrolyte 105 may be in contact with the positive electrode active material 101 via the coating layer 102.

The sulfide solid electrolyte can be, for example, Li₂S—P₂S₅, Li₂S—SiS₂, Li₂S—B₂S₃, Li₂S—GeS₂, Li_{3.25}Ge_{0.25}P_{0.75}S₄, or Li₁₀GeP₂S₁₂. To these, LiX, Li₂O, MO_{q}, LiₚMO_{q}, or the like may be added. Here, X in “LiX” is at least one selected from the group consisting of F, Cl, Br, and I. The element M in “MO_{q}” and “LiₚMO_{q}” is at least one selected from the group consisting of P, Si, Ge, B, Al, Ga, In, Fe, and Zn. The symbols p and q in “MO_{q}” and “LiₚMO_{q}” are each independently a natural number.

The second solid electrolyte 105 includes the sulfide solid electrolyte and may further include a different solid electrolyte. For example, the second solid electrolyte 105 includes the sulfide solid electrolyte and may include at least one selected from the group consisting of an oxide solid electrolyte, a polymer solid electrolyte, and a complex hydride solid electrolyte.

Oxide solid electrolytes are solid electrolytes containing oxygen. The oxide solid electrolyte may further contain an anion other than oxygen, except for sulfur and halogen elements.

The oxide solid electrolyte can be, for example, a NASICON-type solid electrolyte typified by LiTi₂(PO₄)₃ and element-substituted substances thereof, a (LaLi)TiO₃-based perovskite-type solid electrolyte, a LISICON-type solid electrolyte typified by Li₁₄ZnGe₄O₁₆, Li₄SiO₄, and LiGeO₄ and element-substituted substances thereof, a garnet-type solid electrolyte typified by Li₇La₃Zr₂O₁₂ and element-substituted substances thereof, Li₃PO₄ and N-substituted substances thereof, or a glass or glass ceramic based on a material including a Li—B—O compound, such as LiBO₂ or Li₃BO₃, to which a material such as Li₂SO₄ or Li₂CO₃ is added.

The polymer solid electrolyte can be, for example, a compound of a polymer compound and a lithium salt. The polymer compound may have an ethylene oxide structure. The polymer compound having an ethylene oxide structure can contain a large amount of a lithium salt. Accordingly, the ionic conductivity can be further enhanced. Examples of the lithium salt include LiPF₆, LiBF₄, LiSbFe, LiAsFe, LiSO₃CF₃, LiN(SO₂F)₂, LiN(SO₂CF₃)₂, LiN(SO₂C₂F₅)₂, LiN(SO₂CF₃)(SO₂C₄F₉), and LiC(SO₂CF₃)₃. One lithium salt selected from these may be used alone, or a mixture of two or more lithium salts selected from these may be used.

The complex hydride solid electrolyte can be, for example, LiBH₄—LiI or LiBH₄—P₂S₅.

The second solid electrolyte 105 may exhibit higher lithium-ion conductivity than the first solid electrolyte.

The second solid electrolyte 105 may contain an unavoidable impurity, such as a starting material for use in synthesizing the solid electrolyte, a by-product, or a decomposition product. This is also true for the first solid electrolyte.

### <Other Materials>

The positive electrode material 10 may contain a binder for the purpose of improving the adhesion between particles. The binder is used to improve the binding properties of the materials constituting the positive electrode. Examples of the binder include polyvinylidene fluoride, polytetrafluoroethylene, polyethylene, polypropylene, aramid resin, polyamide, polyimide, polyamide-imide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polycarbonate, polyethersulfone, polyetherketone, polyetheretherketone, polyphenylene sulfide, hexafluoropolypropylene, styrene-butadiene rubber, carboxymethyl cellulose, and ethyl cellulose. The additional binder can also be a copolymer of two or more monomers selected from the group consisting of tetrafluoroethylene, hexafluoroethylene, hexafluoropropylene, perfluoroalkyl vinyl ether, vinylidene fluoride, chlorotrifluoroethylene, ethylene, propylene, butadiene, styrene, pentafluoropropylene, fluoromethyl vinyl ether, acrylic acid ester, acrylic acid, and hexadiene. One selected from these may be used alone, or two or more selected from these may be used in combination.

The binder may be an elastomer for its excellent binding properties. An elastomer is a polymer with rubber elasticity. The elastomer used as the binder may be a thermoplastic elastomer or a thermosetting elastomer. The binder may contain a thermoplastic elastomer. Examples of thermoplastic elastomers include styrene-ethylene-butylene-styrene (SEBS), styrene-ethylene-propylene-styrene (SEPS), styrene-ethylene-ethylene-propylene-styrene (SEEPS), butylene rubber (BR), isoprene rubber (IR), chloroprene rubber (CR), acrylonitrile-butadiene rubber (NBR), styrene-butylene rubber (SBR), styrene-butadiene-styrene (SBS), styrene-isoprene-styrene (SIS), hydrogenated isoprene rubber (HIR), hydrogenated butyl rubber (HIIR), hydrogenated nitrile rubber (HNBR), hydrogenated styrene-butylene rubber (HSBR), polyvinylidene fluoride (PVdF), and polytetrafluoroethylene (PTFE). One selected from these may be used alone, or two or more selected from these may be used in combination.

The positive electrode material 10 may further contain a conductive additive for the purpose of enhancing electronic conductivity. The conductive additive can be, for example, graphite, such as natural graphite or artificial graphite, carbon black, such as acetylene black or Ketjenblack, a conductive fiber, such as a carbon fiber or a metal fiber, fluorinated carbon, a metal powder, such as aluminum powder, a conductive whisker, such as a zinc oxide whisker or a potassium titanate whisker, a conductive metal oxide, such as titanium oxide, or a conductive polymer compound, such as a polyaniline, polypyrrole, or polythiophene compound. The use of a conductive carbon additive can achieve cost reduction.

The coating layer 102 may contain the above conductive additive for the purpose of enhancing electronic conductivity.

### <Manufacturing Method for Coated Active Material>

The coated active material 100 can be manufactured by the following method.

A powder of the positive electrode active material 101 and a powder of the first solid electrolyte are mixed in an appropriate ratio to obtain a mixture. The mixture is subjected to a milling process to impart mechanical energy to the mixture. For the milling process, a mixing device, such as a ball mill, can be used. To suppress oxidation of the materials, the milling process may be performed in a dry atmosphere and an inert atmosphere.

The coated active material 100 may be manufactured by a dry particle composing method. Processing by the dry particle composing method includes imparting mechanical energy generated by at least one selected from the group consisting of impact, compression, and shear to the positive electrode active material 101 and the first solid electrolyte. The positive electrode active material 101 and the first solid electrolyte are mixed in an appropriate ratio.

The device used in manufacturing the coated active material 100 is not particularly limited and can be a device capable of imparting mechanical energy generated by impact, compression, and shear to the mixture of the positive electrode active material 101 and the first solid electrolyte. Examples of devices capable of imparting such mechanical energy include ball mills and compression shear type processing devices (particle composing machines), such as “MECHANO FUSION” (manufactured by Hosokawa Micron Corporation) and “NOBILTA” (manufactured by Hosokawa Micron Corporation).

“MECHANO FUSION” is a particle composing machine utilizing a dry mechanical composing technique of imparting high mechanical energy to a plurality of different raw material powders. MECHANO FUSION imparts mechanical energy generated by compression, shear, and friction to raw material powders charged between the rotating vessel and the press head. This produces composite particles.

“NOBILTA” is a particle composing machine utilizing a dry mechanical composing technique developed from particle composing technique in order to perform composing using nanoparticles as the raw material. NOBILTA produces composite particles by imparting mechanical energy generated by impact, compression, and shear to a plurality of raw material powders.

In “NOBILTA”, inside the horizontal cylindrical mixing vessel, the rotor is disposed with a predetermined clearance from the inner wall of the mixing vessel, and the rotor rotates at a high speed to repeat processing of forcibly passing raw material powders through the clearance multiple times. This exerts the force of impact, compression, and shear on the mixture, and thus composite particles of the positive electrode active material 101 and the first solid electrolyte can be produced. The conditions such as the rotational speed of the rotor, the processing time, and the charge amount can be adjusted to control, for example, the thickness of the coating layer 102 or the coverage of the positive electrode active material 101 with the first solid electrolyte.

However, the processing using the above devices is not required. The coated active material 100 may be manufactured by mixing the positive electrode active material 101 and the first solid electrolyte using, for example, a mortar or a mixing device. The first solid electrolyte may be deposited on the surface of the positive electrode active material 101 by various methods such as spraying, spray-dry coating, electrodeposition, immersion, and mechanical mixing with a disperser.

### <Manufacturing Method for Positive Electrode Material>

The positive electrode material 10 is obtained by mixing the coated active material 100 and the second solid electrolyte 105. The method of mixing the coated active material 100 and the second solid electrolyte 105 is not particularly limited. The coated active material 100 and the second solid electrolyte 105 may be mixed using an instrument such as a mortar, or the coated active material 100 and the second solid electrolyte 105 may be mixed using a mixing device, such as a ball mill.

### Embodiment 2

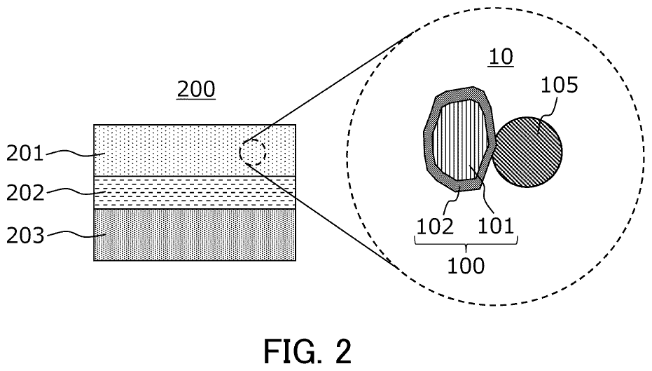

FIG. 2 is a cross-sectional view schematically showing the configuration of a battery according to Embodiment 2. A battery 200 includes a positive electrode 201, a separator layer 202, and a negative electrode 203. The separator layer 202 is disposed between the positive electrode 201 and the negative electrode 203. The positive electrode 201 includes the positive electrode material 10 described in Embodiment 1. According to this configuration, an increase in the internal resistance of the battery 200 can be suppressed.

The positive electrode 201 and the negative electrode 203 may each have a thickness of 10 μm or more and 500 μm or less. When the positive electrode 201 and the negative electrode 203 each have a thickness of 10 μm or more, a sufficient energy density of the battery can be ensured. When the positive electrode 201 and the negative electrode 203 each have a thickness of 500 μm or less, high-output operation of the battery 200 can be achieved.

The separator layer 202 is a layer including an electrolyte material. The separator layer 202 may include at least one solid electrolyte selected from the group consisting of a sulfide solid electrolyte, an oxide solid electrolyte, a halide solid electrolyte, a polymer solid electrolyte, and a complex hydride solid electrolyte. The details of each solid electrolyte are as described in Embodiment 1.

The separator layer 202 may have a thickness of 1 μm or more and 300 μm or less. When the separator layer 202 has a thickness of 1 μm or more, the positive electrode 201 and the negative electrode 203 can be more reliably separated from each other. When the separator layer 202 has a thickness of 300 μm or less, high-output operation of the battery 200 can be achieved.

The negative electrode 203 includes, as the negative electrode active material, a material having properties of occluding and releasing metal ions (e.g., lithium ions).

The negative electrode active material can be a metal material, a carbon material, an oxide, a nitride, a tin compound, a silicon compound, or the like. The metal material may be a simple substance of metal. Alternatively, the metal material may be an alloy. Examples of the metal material include lithium metal and a lithium alloy. Examples of the carbon material include natural graphite, coke, partially graphitized carbon, carbon fiber, spherical carbon, artificial graphite, and amorphous carbon. From the viewpoint of capacity density, silicon (Si), tin (Sn), a silicon compound, a tin compound, or the like can be suitably used.

The particles of the negative electrode active material may have a median diameter of 0.1 μm or more and 100 μm or less.

The negative electrode 203 may include other materials such as a solid electrolyte. The solid electrolyte can be any of the materials described in Embodiment 1.

### Other Embodiments

### (Supplementary Description)

The above description of the embodiments discloses the following techniques.

### (Technique 1)

A positive electrode material including:
a coated active material including a positive electrode active material and a coating layer including a first solid electrolyte, the coating layer coating at least a portion of a surface of the positive electrode active material; and
a second solid electrolyte, wherein
the first solid electrolyte includes Li, Ti, M, and X,
the M is at least one selected from the group consisting of metalloid elements and metal elements except for Li and Ti,
the X is at least one selected from the group consisting of F, Cl, Br, and I,
the second solid electrolyte includes Li and S, and
a ratio of a mass of the first solid electrolyte to a total mass of the positive electrode active material and the first solid electrolyte is 1.00% or more and 4.10% or less.

According to this configuration, an increase in the internal resistance of the battery can be suppressed.

### (Technique 2)

The positive electrode material according to Technique 1, wherein the ratio is 1.6% or more and 3.6% or less. According to this configuration, an increase in the internal resistance of the battery can be further suppressed.

### (Technique 3)

The positive electrode material according to Technique 1 or 2, wherein a specific surface area is 0.6 m²/g or more and 1.4 m²/g or less. According to this configuration, an increase in the internal resistance of the battery can be suppressed.

### (Technique 4)

The positive electrode material according to any one of Techniques 1 to 3, wherein the M includes at least one selected from the group consisting of Ca, Mg, Al, Y, and Zr. According to this configuration, the first solid electrolyte exhibits high ionic conductivity.

### (Technique 5)

The positive electrode material according to any one of Techniques 1 to 4, wherein the M includes Al. According to this configuration, the first solid electrolyte exhibits high ionic conductivity.

### (Technique 6)

The positive electrode material according to any one of Techniques 1 to 5, wherein the first solid electrolyte is represented by the following composition formula (1):

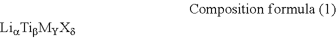

in the composition formula (1), α, β, γ, and δ are each independently a value greater than 0. When the first solid electrolyte represented by the composition formula (1) is used in a battery, the output characteristics of the battery can be improved.

### (Technique 7)

The positive electrode material according to one of Techniques 1 to 6, wherein the first solid electrolyte is represented b the following composition formula (2):

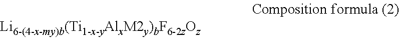

in the composition formula (2), M2 is at least one selected from the group consisting of Zr, Ni, Fe, and Cr, m is a valence of M2, and 0.1<x<0.9, 0≤y<0.1, 0≤z<0.1, and 0.8<b≤1.2 are satisfied. According to this configuration, the output characteristics of the battery can be improved.

### (Technique 8)

A positive electrode including the positive electrode material according to any one of Techniques 1 to 7. According to this configuration, an increase in the internal resistance of the battery can be suppressed.

### (Technique 9)

A battery including the positive electrode according to Technique 8. According to this configuration, an increase in the internal resistance of the battery can be suppressed.

### EXAMPLES

The details of the present disclosure are described below using examples and a comparative example. The electrode and the battery of the present disclosure are not limited to the following examples.

### Example 1

### [Preparation of First Solid Electrolyte]

In an argon glove box with a dew point of −60° C. or less, LiF, TiF₄, and AlF₃ as the raw material powders were weighed in a molar ratio of LiF:TiF₄:AlF₃=2.5:0.5:0.5. These were pulverized and mixed in a mortar to obtain a mixture. The mixed powder thus obtained was subjected to a milling process using a planetary ball mill for 12 hours at 500 rpm. Thus, a powder of a halide solid electrolyte was obtained as the first solid electrolyte of Example 1. The first solid electrolyte according to Example 1 had a composition represented by Li_{2.5}Ti_{0.5}Al_{0.5}F₆ (hereinafter referred to as “LTAF”).

### [Preparation of Coated Active Material]

A powder of Li(NiCoAl)O₂ (hereinafter referred to as “NCA”) was prepared as the positive electrode active material. A coating layer formed of the LTAF was formed on the surface of the NCA. The coating layer was formed by shearing using a particle mixing device (BALANCE GRAN, manufactured by Freund-Turbo Corporation). Specifically, the NCA and the LTAF were weighed in a mass ratio of 98.9:1.1, and processed at a rotational speed of 3100 rpm for a processing time of 1 hour. The coated active material of Example 1 was thus obtained. The coated active material of Example 1 had a specific surface area of 0.68 m²/g.

### [Preparation of Second Solid Electrolyte]

In an argon glove box with a dew point of −60° C. or less, Li₂S and P₂S₅ as the raw material powders were weighed in a molar ratio of Li₂S:P₂S₅=75:25. These were pulverized and mixed in a mortar to obtain a mixture. The mixture was then subjected to a milling process using a planetary ball mill (Model P-7, manufactured by Fritsch GmbH) for 10 hours at 510 rpm. Thus, a glassy solid electrolyte was obtained. The glassy solid electrolyte was heat-treated in an inert atmosphere at 270° C. for 2 hours. Thus, a glass-ceramic sulfide solid electrolyte Li₂S—P₂S₅ (hereinafter referred to as “LPS”) was obtained as the second solid electrolyte.

### [Preparation of Positive Electrode Material]

In an argon glove box, the coated active material and the LPS of Example 1 were weighed so that the volume ratio of the coated active material to the sulfide solid electrolyte was 70:30. These were mixed in an agate mortar to prepare the positive electrode material of Example 1.

### Example 2

The coated active material of Example 2 was obtained in the same manner as in Example 1, except that the mass ratio of the NCA to the LTAF was changed to 98.39:1.61. The coated active material of Example 2 had a specific surface area of 0.81 m²/g.

Using the coated active material of Example 2, the positive electrode material of Example 2 was obtained in the same manner as in Example 1.

### Example 3

The coated active material of Example 3 was obtained in the same manner as in Example 1, except that the mass ratio of the NCA to the LTAF was changed to 97.55:2.45. The coated active material of Example 3 had a specific surface area of 1.10 m²/g.

Using the coated active material of Example 3, the positive electrode material of Example 3 was obtained in the same manner as in Example 1.

### Example 4

The coated active material of Example 4 was obtained in the same manner as in Example 1, except that the mass ratio of the NCA to the LTAF was changed to 96.42:3.58. The coated active material of Example 4 had a specific surface area of 1.15 m²/g.

Using the coated active material of Example 4, the positive electrode material of Example 4 was obtained in the same manner as in Example 1.

### Example 5

The coated active material of Example 5 was obtained in the same manner as in Example 1, except that the mass ratio of the NCA to the LTAF was changed to 95.99:4.01. The coated active material of Example 5 had a specific surface area of 1.16 m²/g.

Using the coated active material of Example 5, the positive electrode material of Example 5 was obtained in the same manner as in Example 1.

### Comparative Example 1

The NCA that was not coated with the LTAF was used as the active material of Comparative Example 1. The active material of Comparative Example 1 had a specific surface area of 0.55 m²/g.

In the positive electrode materials of Examples 1 to 5 and Comparative Example 1, the ratio of the mass of the LTAF to the total mass of the NCA and the LTAF, expressed in percentage, was as shown in Table 1. In Table 1, the “ratio of the mass of the LTAF to the total mass of the NCA and the LTAF” is represented as “LTAF/(LTAF+NCA) (mass %)”.

### [Fabrication of Battery]

The positive electrode material was weighed so that 14 mg of the NCA was contained. The LPS and the positive electrode material were stacked in this order in an insulating outer cylinder. The resulting stack was formed under a pressure of 720 MPa. Next, metallic lithium was disposed in contact with the LPS layer and the resulting stack was further formed under a pressure of 40 MPa. Thus, a stack composed of a positive electrode, a solid electrolyte layer, and a negative electrode was obtained. Next, current collectors made of stainless steel were disposed on the top and bottom of the stack. Current collector leads were attached to the current collectors. Next, the outer cylinder was sealed with an insulating ferrule to block the inside of the outer cylinder from the external atmosphere. Through the above process, the batteries of Examples 1 to 5 and Comparative Example 1 were fabricated. The battery was clamped from above and below with four bolts to apply a surface pressure of 150 MPa to the battery.

### [Storage Test]

The battery was placed in a thermostatic chamber set at 25° C. The battery was subjected to a constant-current charge at a current value of 147 pA equivalent to a 0.05C rate (20-hour rate) relative to the theoretical capacity of the battery until a voltage of 4.3 V was reached. The battery was then subjected to a constant-current discharge at a current value of 147 μA equivalent to a 0.05C rate (20-hour rate) relative to the theoretical capacity of the battery until a voltage of 3.7 V was reached. The battery was then subjected to a constant-current discharge for 0.1 seconds at a current value of 0.136 A equivalent to a 46.4C rate relative to the theoretical capacity of the battery, and the resistance value of the battery before the storage test was determined from the voltage drop during the discharge.

Next, the internal temperature of the thermostatic chamber was changed to 80° C. and the battery was stored for one week with the battery charged to 4.1 V.

Next, the internal temperature of the thermostatic chamber was returned to 25° C. and the battery was subjected to a constant-current charge at a current value of 147 μA equivalent to a 0.05C rate (20-hour rate) relative to the theoretical capacity of the battery until a voltage of 4.3 V was reached. The battery was then subjected to a constant-current discharge at a current value of 147 μA equivalent to a 0.05C rate (20-hour rate) relative to the theoretical capacity of the battery until a voltage of 3.7 V was reached. The battery was then subjected to a constant-current discharge for 0.1 seconds at a current value of 0.136 A equivalent to a 46.4C rate relative to the theoretical capacity of the battery, and the resistance value of the battery after the storage test was determined from the voltage drop during the discharge.

The results of the storage test are shown in Table 1. In Table 1, “Resistance increase rate” is the value calculated by the mathematical formula: 100×(resistance value after storage test)/(resistance value before storage test).

TABLE 1

| | | Specific | | | |
|---|---|---|---|---|---|
| | | surface | Resistance | Resistance | |
| | | area of | value | value | |
| | LTAF/ | coated | before | after | Resistance |
| | (LTAF + | active | storage | storage | increase |
| | NCA) | material | test | test | rate |
| | (mass %) | (m²/g) | (Ω) | (Ω) | (%) |
| Example 1 | 1.10 | 0.68 | 3.5 | 4 | 114.3 |
| Example 2 | 1.61 | 0.81 | 3.5 | 3.9 | 111.4 |
| Example 3 | 2.45 | 1.10 | 3.7 | 4.2 | 113.5 |
| Example 4 | 3.58 | 1.15 | 3.7 | 4.2 | 113.5 |
| Example 5 | 4.01 | 1.16 | 3.8 | 4.2 | 110.5 |
| Comparative | 0 | — | 15.7 | 73.9 | 470.7 |
| Example 1 | | | | | |

### <Discussion>

As shown in Table 1, in Examples 1 to 5 in which the positive electrode active material was coated with the first solid electrolyte, which is a halide solid electrolyte, the increase in resistance due to storage was suppressed. Furthermore, Examples 1 to 5 exhibited lower resistance values before the storage test than Comparative Example 1. This is presumed to be due to the suppression of the reaction between the oxygen released from the positive electrode active material and the sulfide solid electrolyte. Thus, in Examples 1 to 5, the values of the internal resistance of the batteries and the increase in the internal resistance due to storage were suppressed.

It has been confirmed that even when at least one selected from the group consisting of metalloid elements and metal elements except for Li and Ti, for example, Ca, Mg, Al, Y, or Zr is used instead of Al, the halide solid electrolyte exhibits comparable ionic conductivity (for example, in JP 2020-048461 filed by the present applicant). Therefore, it is possible to use a halide solid electrolyte including at least one selected from the group consisting of these elements, instead of Al or together with Al. Even in such cases, it is still possible to charge and discharge the battery and achieve the effect that the oxidation reaction of the sulfide solid electrolyte is suppressed and thereby an increase in resistance is suppressed.

Moreover, the main cause of oxidation of a sulfide solid electrolyte is extraction of electrons from the sulfide solid electrolyte due to contact of the sulfide solid electrolyte with a positive electrode active material. Therefore, according to the technique of the present disclosure, it is possible to achieve the effect that the oxidation of the sulfide solid electrolyte is suppressed even when an active material other than NCA is used.

### INDUSTRIAL APPLICABILITY

The technique of the present disclosure is useful, for example, for all-solid-state lithium secondary batteries.

What is claimed is:

1. A positive electrode material comprising:
a coated active material comprising a positive electrode active material and a coating layer comprising a first solid electrolyte, the coating layer coating at least a portion of a surface of the positive electrode active material; and
a second solid electrolyte, wherein
the first solid electrolyte comprises Li, Ti, M, and X,
the M is at least one selected from the group consisting of metalloid elements and metal elements except for Li and Ti,
the X is at least one selected from the group consisting of F, Cl, Br, and I,
the second solid electrolyte comprises Li and S, and
a ratio of a mass of the first solid electrolyte to a total mass of the positive electrode active material and the first solid electrolyte is 1.00% or more and 4.10% or less.

2. The positive electrode material according to claim 1, wherein
the ratio is 1.6% or more and 3.6% or less.

3. The positive electrode material according to claim 1, wherein
a specific surface area is 0.6 m²/g or more and 1.4 m²/g or less.

4. The positive electrode material according to claim 1, wherein
the M comprises at least one selected from the group consisting of Ca, Mg, Al, Y, and Zr.

5. The positive electrode material according to claim 1, wherein
the M comprises Al.

6. The positive electrode material according to claim 1, wherein
the first solid electrolyte is represented by the following composition formula (1): 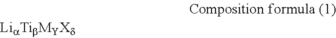
in the composition formula (1), α, β, γ, and δ are each independently a value greater than 0.

7. The positive electrode material according to claim 1, wherein
the first solid electrolyte is represented by the following composition formula (2): 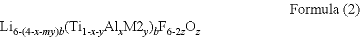
in the composition formula (2),
M2 is at least one selected from the group consisting of Zr, Ni, Fe, and Cr,
m is a valence of M2, and
0.1<x<0.9, 0≤y<0.1, 0≤z<0.1, and 0.8<b≤1.2 are satisfied.

8. A positive electrode comprising the positive electrode material according to claim 1.

9. A battery comprising the positive electrode according to claim 8.
